(19) United States
(12) Patent Application Publication
(10) Pub. No.: US 2005/0102412 A1
(43) Pub. Date: May 12, 2005

(54) Transmission performance of a transport layer protocol connection

(76) Inventor: Jan Hirsimaki, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/705,759

(22) Filed: Nov. 10, 2003

(51) Int. Cl. G06F 15/16

(52) U.S. Cl. 709/232

(57) ABSTRACT

The invention relates to a method, a computer program product, a mobile terminal, a device and a system for improving the performance of a Transport Layer Protocol (TLP) connection that uses a data transmission service of a bearer, comprising monitoring data traffic of said TLP connection and dynamically adjusting a transmission capacity of said bearer according to said monitored data traffic of said TLP connection.

### FIELD OF THE INVENTION

The invention relates to a method, a computer program product, a mobile terminal, a device and a system for improving the transmission performance of a transport layer protocol connection that uses a data transmission service of a bearer.

### BACKGROUND OF THE INVENTION

In the framework of the evolution of the Global System for Mobile Communication (GSM) towards Third-Generation (3G) mobile communication systems known as the Universal Mobile Telecommunication System (UMTS), new standards are presently integrated into the existing mobile radio networks. The driving force for this development is the predicted user demand for mobile data services that will offer mobile multimedia applications and mobile Internet access.

In this context, the High-Speed Circuit-Switched Data (HSCSD) has been introduced in some countries in 1999, whereas the General Packet Radio Service (GPRS) has been established in 2001 in Europe and many countries world-wide. With these new services mobile multimedia applications with net bit rates of up to 117 kbit/s have been established on the market. To realize mobile real-time applications as the next step the European Telecommunications Standards Institute (ETSI) has been developing the Enhanced Data Rates for the GSM Evolution (EDGE) standard, which offers a net bit rate of up to 384 kbit/s by means of modified modulation, coding and medium access techniques. The packet-oriented part is the Enhanced General Packet Radio Service (EGPRS). The circuit-switched part is the Enhanced Circuit-Switched Data (ECSD) that extends the capabilities of HSCSD.

If mobile Internet access is to be provided with the above-mentioned mobile radio standards as bearer services, the characteristics of the Internet have to be taken into consideration. The Internet can be imagined as a black box consisting of an unknown number of nodes and routes between them. It provides an unreliable transport of IP packets, which means that packet losses are natural. It is up to the network peers to ensure transport reliability, if required by the application. This is the case for an application like the World Wide Web (WWW), because only complete Web-pages are acceptable. The same holds for file transfers.

The Transport Layer Protocol (TCP) is the most commonly used transport layer protocol in the Internet, if data reliability needs to be ensured. Some features of TCP heavily influence the end-to-end performance of wireless networks and will be briefly summarized in what follows.

TCP is a connection-oriented protocol comprising an Adaptive Repeat Request (ARQ) functionality to ensure reliability and in-sequence delivery. Since packet losses in the Internet are mostly due to congestion and buffer overflow in a network node, TCP also includes functionality for congestion control. Basically, it uses IP packet losses as congestion signals and adapts its transmission rate by reducing the transmission window size. Based on the assumption that congestion causes packet losses, the functionality for congestion control and error recovery are intertwined in TCP.

FIG. 1 depicts a block diagram of a state-of-the-art system that offers mobile Internet access similar to the Open Systems Interconnection (OSI) seven-layer-model of the International Standardization Organization (ISO). The system comprises a protocol stack of a mobile terminal (10, 20, 30), a protocol stack at a core network (10′, 20′, 30′) and a protocol stack of a relay station (40, 40′, 50).

At the mobile terminal, a transport layer 10 resides on top of the three lowest protocol layers of the OSI model which offer the bearer service to the transport layer 10 and will thus be referred to as bearer layer 20. Above the transport layer 10, an application layer 30 is depicted, which may comprise applications according to the File Transfer Protocol (FTP), Telnet protocol, Simple Mail Transfer Protocol (SMTP), Net News Transfer Protocol (NNTP) or World Wide Web (WWW). For data exchange between said application layer 30 of a mobile terminal and a peer application layer 30′ of a core network or another network entity, said application layer uses the connection-oriented service of the Transport Layer Protocol (TLP), which may for instance be the Transport Control Protocol (TCP) or the User Datagram Protocol (UDP). In the description of FIG. 1 which follows, the use of the TCP will be exemplarily assumed.

To this end, in the transport layer 10, an incoming data stream 101 originating from said application layer 30 is transformed into TCP segments 102 by a transformation instance 103a and subsequently buffered in a TCP segment buffer 104a. The TCP segments 102 are actually to be sent to a peer transport layer 10′ in the core network protocol stack via a TCP connection.

This transmission service is offered to the TCP layer by the bearer layer 20. To this end, TCP segments 102 are transferred to a transformation instance 201a, where they are transformed into suitable bearer packets 202, and subsequently buffered in a bearer packet buffer 203a. The transfer of the TCP segments 102 to the transformation instance 201a is controlled by the TCP buffer controller 105a, which in turn is controlled by the TCP controller 106. TCP segments 102 from said TCP segment buffer 104a are only transferred to said transformation instance 201a if the TCP controller 106, that operates the TCP together with a peer TCP controller in peer transport layer 10′, has scheduled said TCP segment 102 for transmission by the bearer services offered by the bearer layer 20. For instance, said TCP controller 106 may schedule said TCP segment 102 only for transmission if acknowledgments of previously transmitted TCP segments 102 have been received from said peer transport layer 10′, accordingly.

Under the control of a bearer packet buffer controller 204a, which in turn is controlled by a bearer service control instance 205, a bearer packet 202 then is transferred to the bearer interface 206. Between said bearer interface 206 and a peer bearer interface in a peer bearer layer 40 of a relay station (40, 40′, 50), for instance a base station of a wireless system, a wireless bearer transmission link 60a is established, over which bearer packets 202 are transmitted.

In said relay station, the protocol stack of said peer bearer layer 40, which is at least compatible with the protocol stack of the bearer layer 20, is translated into a protocol stack of a further bearer layer 40′ by means of a relay function 50. The protocol stack of the further bearer layer 40′ is compatible with a protocol stack of a bearer layer 20′ in said core network and operates a transmission link 70 between said relay station (40, 40′, 50) and said core network (10′, 20′, 30′). The bearer packets 202 from said bearer layer 20 thus are transferred over said wireless bearer transmission link 60a to said relay station, and then transferred to said core network over said transmission link 70, which may either be a wireless or wired link. The use of a relay function 50 in said relay station may be necessary due to the different transmission characteristics of the wireless bearer transmission link 60a, 60b and the transmission link 70, that may require different protocol stacks for the bearer layers 20 and 40 on the one hand, and the bearer layers 40′ and 20′ on the other hand. However, the bearer layers 40, 40′ and 20′ comprise similar functional blocks as the bearer layer 20, and the peer transport layer 10′ comprises similar functional blocks as the transport layer 10.

The above description of a state-of-the-art system that offers mobile Internet access concentrated on the uplink situation, wherein a data stream 101 from an application layer 30 of a mobile terminal was transmitted to a peer application layer 10′ in a core network by using the services of a TCP and two bearers. Quite similarly, in the downlink situation, data streams originating from said application layer 30′ of said core network or other network entity can be transmitted to said application layer 30 of said mobile terminal. Between said relay station (40, 40′, 50) and said mobile terminal (10, 20, 30), then a wireless bearer transmission link 60b is used, and, corresponding to the uplink, the bearer packets 202 pass through the interface 206, a bearer packet buffer controller 204b, a bearer packet buffer 203b, a transformation instance 201b, a TCP segment buffer controller 105b, a TCP segment buffer 104b and a transformation instance 103b. As on the uplink, also on the downlink the bearer packet buffer controller 204b is controlled by the bearer service controller 205, and the TCP segment buffer controller 105b is controlled by the TCP controller 106.

In the state-of-the-art system of FIG. 1, the capacity in terms of transmittable bearer packets per time of said wireless bearer transmission links 60a and 60b is determined by a resource allocation instance 207, with a corresponding resource allocation instance in said bearer layer 40 of said relay station.

Said resource allocation instances determine the capacity that is required for the uplink and downlink transmission of bearer packets either during setup of the connection between the mobile terminal and the core network, as it is for instance the case in circuit-switched networks, or based on the state of the bearer packet buffers 203a, 203b in said bearer layer 20 and 40, as it is for instance the case in packet-switched networks.

In many cases, said wireless bearer transmission links 60a, 60b are loaded asymmetrically, i.e. there is usually more throughput towards the downlink direction than towards the uplink direction. This is advantageous in cases where the mobile terminal downloads huge amounts of data from the core network, as it is for instance the case with web-browsing or similar applications. In the uplink direction, then only TCP segments 102 with acknowledgments of the received downlink TCP segments have to be transmitted on the uplink, and it is sufficient to allocate only little capacity to the uplink bearer transmission link 60a.

However, when the mobile terminal starts to send increased amounts of TCP segments 102 towards the uplink direction, e.g. sending a mail or Multimedia Messaging Service (MMS) content, transmission of said uplink TCP segments 102 is slowed down substantially due to the limited capacity of the uplink bearer transmission link 60a. Uplink TCP segments 102 are then buffered in said bearer packet buffer 203a, and overflows of said bearer packet buffer 203a and/or said TCP segment buffer 104a might occur. Even worse, overloading the uplink bearer transmission link 60a with uplink TCP segments necessarily also delays the transmission of uplink acknowledgments for already successfully received downlink TCP segments. Because the TCP controller in said TCP layer 10′ of said core network or other network entity waits for acknowledgments of already transmitted downlink TCP segments before instructing its TCP segment buffer controller to transfer further downlink TCP segments 102 to the bearer layer 20′ for transmission, and because these acknowledgments may be substantially delayed due to the overload of the uplink bearer transmission link 60a, the transmission of downlink TCP segments via said wireless bearer transmission link 60b may be slowed down or entirely blocked, although its capacity is actually sufficient to allow for speedy transmission of the downlink TCP segments.

This situation is aggravated by the self-clocking feature of the TCP protocol: The faster acknowledgments are received, the faster further TCP segments 102 are transmitted. With the reception of acknowledgments being substantially delayed due to insufficient uplink capacity, the transmission of downlink TCP segments 102 is further delayed due to increased TCP segment transmission window sizes.

A further aggravation of this situation arises when the uplink TCP segments 102 are bound for different TCP connections or TCP sockets (in FIG. 1, only one TCP connection is exemplarily depicted, which is controlled by the TCP controller 106). The acknowledgments for successfully received downlink TCP segments can then not be transmitted piggy-backed to uplink TCP segments, and further specific acknowledgment TCP segments have to be transmitted on the uplink.

### SUMMARY OF THE INVENTION

An inventive method is taught herein for improving the transmission performance of a Transport Layer Protocol (TLP) connection that uses a data transmission service of a bearer, said method comprising monitoring data traffic of said TLP connection and dynamically adjusting a transmission capacity of said bearer according to said monitored data traffic of said TLP connection.

A Transport Layer Protocol (TLP) is generally to be understood as any protocol that provides a reliable, acknowledged transfer of data between at least two nodes of a network. Said TLP may for instance be the Transport Control Protocol (TCP) or the User Datagramm Protocol (UDP). Said data is transferred between said at least two nodes of said network via at least one TLP connection, which might be a logical or a physical connection. The transmission performance of said TLP connection may for instance be assessed by its throughput, delay characteristics, or both. Monitoring said data traffic of said TLP connection may be performed in at least one transmission direction, for instance either in the uplink/upstream direction or in the downlink/downstream direction, or both. Said monitoring may be performed by observing a buffer state or by analyzing the temporal characteristics of data streams or TLP segments that come in or go out of the instances that implement said TLP and thus represent the data traffic of said TLP connection. Said temporal characteristics may for instance indicate that TLP segments come into said TLP segments in periodic intervals, or in bursts. Said data may stem from protocol layers above the transport layer, such as data according to the File Transfer Protocol (FTP), Telnet protocol, Simple Mail Transfer Protocol (SMTP), Net News Transfer Protocol (NNTP) or World Wide Web (WWW). Said bearer may either be based on a wired or wireless bearer transmission link and be capable of transmitting TLP segments or parts or combinations thereof over said bearer transmission link. Said bearer service may offer an interface for said TCP so that its transmission capacity can be adjusted. The transmission capacity may be measured in data amount per time. The dynamic adjustment of the transmission capacity is able to react to substantial changes in said data traffic of said TLP connection even after said bearer transmission link of said bearer has been set up. Both the monitoring and the adjustment may take place in protocol instances of said TCP on both sides of the TLP connection or one side of the connection only.

According to an embodiment of the present invention, said TLP may be the Transport Control Protocol (TCP) or the User Datagram Protocol (UDP).

According to an embodiment of the present invention, transmission capacity adjustment information is signaled from at least one TLP instance to at least one bearer instance. Said transmission capacity adjustment information may comprise a number of counted TLP segments, or a number of counted TLP segments per time, or a buffer state, or already adjusted parameters such as a required transmission rate, or the number of transmission links, etc. It is signaled from at least one TLP instance, i.e. an instance in the transport layer, to at least one bearer instance, i.e. an instance in the protocol layers that offer said bearer service.

According to an embodiment of the present invention, said bearer provides uplink and downlink transmission capacity, said data traffic of said TLP connection comprises uplink and downlink data traffic that is separately monitored, and said uplink and downlink transmission capacity is at least partially separately adjusted according to said monitored respective uplink and downlink data traffic.

Said uplink and downlink data traffic of said TLP connection may for instance be data traffic from a mobile terminal of a wireless communication system to a core network and vice versa. Said uplink and downlink data traffic may be separately monitored and transmission capacity on corresponding uplink and downlink bearer transmission links may be accordingly adjusted.

According to an embodiment of the present invention, said uplink and downlink data traffic is at least partially asymmetric. For instance, there may be much more downlink data traffic than uplink data traffic for the majority of the time, so that less transmission capacity is required for the uplink bearer transmission link. When the amount of uplink data traffic temporarily increases, the increase in uplink data traffic may be observed and the corresponding uplink transmission capacity of an uplink bearer transmission link may be dynamically increased, accordingly.

According to an embodiment of the present invention, said data traffic of said TLP connection is monitored at least partially by monitoring a state of at least one TLP segment buffer. This may take place in TLP instances on either side of the TLP connection and for both an uplink and/or downlink TLP segment buffer.

According to an embodiment of the present invention, said data traffic of said TLP connection is monitored at least partially by monitoring data input to at least one TLP socket. TLP sockets represent an application that is accessible via a TLP port. TLP connections end in these ports. If a user uses an application by inputting data, it may be advantageous to monitor the amount of data input to the corresponding socket in order to determine the increase in TLP segments that will have to be transmitted and/or received under the control of said TLP.

According to an embodiment of the present invention, said bearer is a packet-switched or circuit-switched bearer. In a packet-switched bearer, the bearer transmission link will only be established for the transmission of one TLP segment or parts thereof. In a circuit-switched bearer, said bearer transmission link generally is established for several TLP segment transmissions, for instance for a whole Internet session or for the transmission of a complete MMS message.

According to an embodiment of the present invention, said bearer is at least partially based on wireless transmission. Said bearer may for instance be implemented by the three lower layers of a protocol stack of a wireless communications system.

According to an embodiment of the present invention, said bearer is the High-Speed Circuit Switched Data (HSCSD) bearer of a Global System for Mobile Communication (GSM) or of a derivative thereof. Derivatives are to be understood as any future advancements of said GSM.

According to an embodiment of the present invention, said transmission capacity of said bearer is adjusted according to said monitored data traffic of said TLP connection by changing a maximum number of traffic channels and/or at least one air interface user rate parameter. Said at least one air interface user rate parameter may for instance be a bit rate such as 4.8 kbit/s, 9.6 kbit/s, 14.4 kbit/s, etc.

In a HSCSD bearer, the transmission capacity of the bearer is at least partially characterized by the number of parallel traffic channels. The number of traffic channels then may be dynamically altered in correspondence to the increasing or decreasing uplink or downlink traffic, or both, and does not necessarily have to equal the number of traffic channels that was negotiated or fixed during setup of the circuit-switched call.

According to an embodiment of the present invention, said change is performed by using a Call Control (CC) User Initiated Service Level (UISL) up- and downgrading procedure. This procedure aims at changing said maximum number of traffic channels, changing the air interface user rate parameter, or both.

According to another embodiment of the present invention, said bearer is a General Packet Radio Service (GPRS) bearer or an Enhanced GPRS (EGPRS) bearer of a Global System for Mobile Communications (GSM) or of a derivative thereof. These bearers are packet-switched bearers.

In case of an (E)GPRS bearer, said transmission capacity of said bearer may be adjusted according to said monitored data traffic of said TLP connection by influencing a Temporary Block Flow (TBF) setup. Transmission capacity requirements of said TLP connection may be signaled to said (E)GPRS bearer at least partially before TLP segments are transferred to said bearer for transmission over said bearer transmission link. The bearer then has more time to adjust the transmission capacity of the bearer transmission link to the needs of the TLP, and does not have to determine the required transmission capacity based on the state of its bearer packet buffers.

According to another embodiment of the present invention, said bearer is a bearer that uses Code Division Multiple Access (CDMA) as a medium access technique, in particular a bearer of an IS-95 system or of a derivative thereof.

According to another embodiment of the present invention, said bearer is a Universal Mobile Telecommunications System (UMTS) bearer or a bearer of a derivative of said system.

Furthermore, a computer program with instructions operable to cause a processor to perform the above-described method steps is provided.

Furthermore, a computer program product comprising a computer program with instructions operable to cause a processor to perform the above-described method steps is provided.

Said processor may for instance be part of a mobile terminal in a wireless communication system or may be integrated in a core network of such a system.

In further accord with the present invention, a device is provided for improving the transmission performance of a Transport Layer Protocol (TLP) connection that uses a data transmission service of a bearer, said device comprising means for monitoring the data traffic of said TLP connection and means for dynamically adjusting the transmission capacity of said bearer according to said monitored data traffic of said TLP connection. Said device may be part of a mobile terminal, a base station or a core network in a wireless communication system.

In still further accord with the present invention a mobile terminal us provided using a Transport Layer Protocol (TLP) connection that uses the data transmission services of a bearer, said mobile terminal comprising means for monitoring data traffic of said TLP connection and means for dynamically adjusting the transmission capacity of said bearer according to said monitored data traffic of said TLP connection. Said mobile terminal may be operating in a wireless communication system.

Still further in accord with the present invention, a system is provided that comprises at least one terminal, and at least one network interface, wherein said at least one terminal and said at least one network interface use a Transport Layer Protocol (TLP) connection that uses a data transmission service of a bearer, wherein data traffic of said TLP connection is monitored and wherein a transmission capacity of said bearer is dynamically adjusted according to said monitored data traffic of said TLP connection. Said system may for instance be a wireless communication system.

These and other aspects of the invention will be apparent from and elucidated with reference to the embodiments described hereinafter.

### BRIEF DESCRIPTION OF THE DRAWINGS

In the figures show:

FIG. 1: A block diagram of a system operating a Transport Layer Protocol (TLP) on top of a bearer service according to the prior art,

FIG. 2: a block diagram of a system operating a Transport Layer Protocol (TLP) on top of a bearer service according to an embodiment of the present invention, and

FIG. 3: a flow chart of the method according to an embodiment of the present invention.

### DETAILED DESCRIPTION OF THE INVENTION

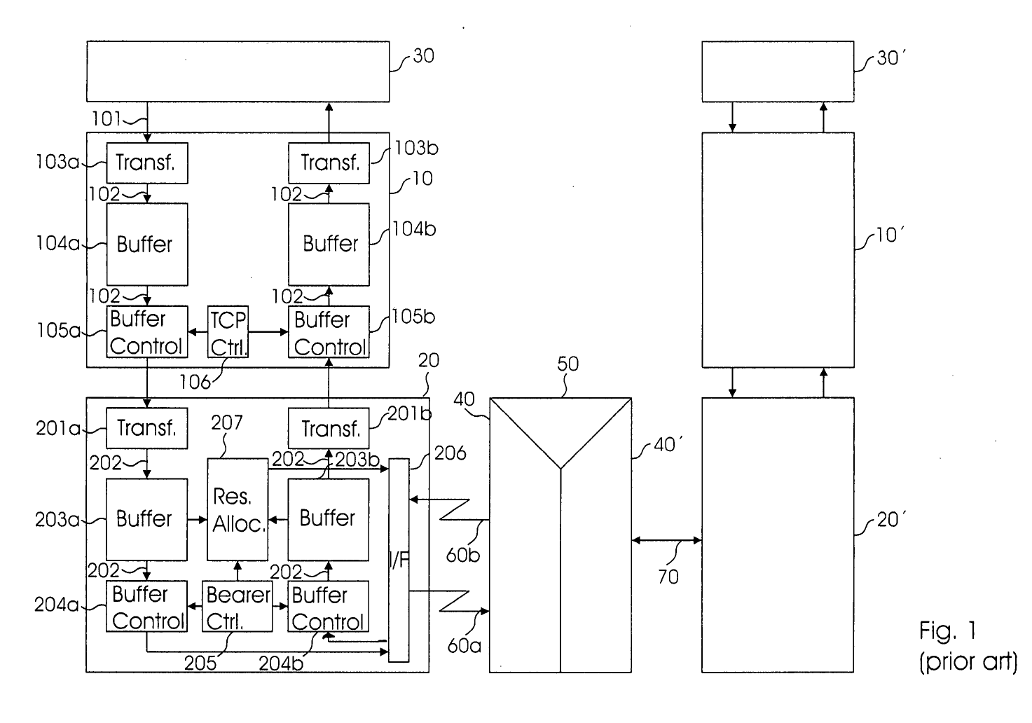

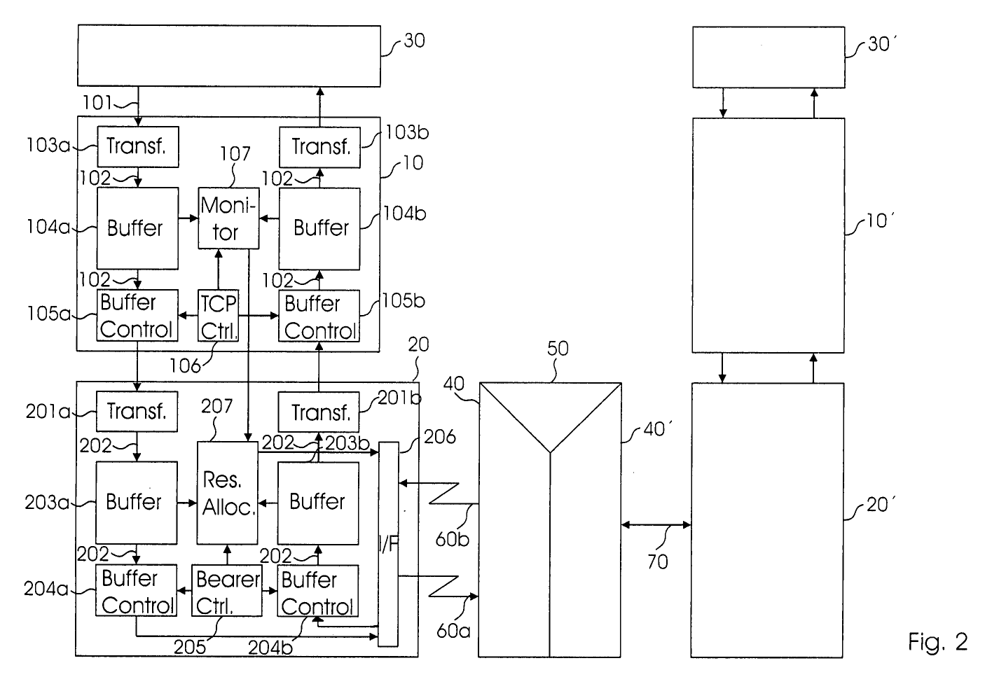

FIG. 2 depicts a block diagram of a system operating a Transport Control Protocol (TCP) as one possible implementation of a Transport Layer Protocol (TLP) on top of a bearer service according to an embodiment of the present invention. The basic set-up of the system is the same as that of the prior art system depicted in FIG. 1. However, in the TCP layer 10, an additional monitoring instance 107 is provided, which is capable of monitoring the flow of TCP segments 102 into TCP segment buffer 104a and out of TCP segment buffer 104b, and capable of monitoring the state of said buffers 104a and 104b. Said monitoring instance 107 also receives an input signal from the TCP controller 106. In addition to the raw flow of TCP segments in connection with the temporal behavior of the TCP traffic in both the uplink and the downlink direction, as monitored by said monitoring instance 107, also TCP information from said TCP controller 106 is made available to said monitoring instance. Said instance thus may be further informed on the average duration of acknowledgments, the transmission window size of a TCP connection, etc. The monitoring instance 107 processes the monitored data traffic and generates control signals that are sent to the resource allocation instance 207 of the bearer layer 20. Such control signals may for instance comprise the desired transmission rate on the transmission links 60a and/or 60b. A similar monitoring instance may be included in a TCP layer 10′ of the core network.

For instance, if said system represents a High-Speed Circuit-Switched Data (HSCSD), said resource allocation instance 207 has established the wireless bearer transmission links 60a and 60b during setup of the circuit-switched call, e.g. because a browser was started on a mobile terminal by a user. Said resource allocation instance 207 has chosen pre-defined parameters for the transmission capacity of the bearer transmission links 60a and 60b, which in many cases will be asymmetric, e.g., on account of the nature of the web-browsing traffic. The uplink transmission direction 60a thus is assigned a smaller capacity than the downlink direction 60b. During web browsing and a parallel file download, said user now discovers interesting content and wants to send this content to a friend via the Multimedia Messaging Service (MMS). In a prior art system, the small amount of uplink transmission capacity will not be sufficient to transmit the MMS message without delaying acknowledgments for received downlink TCP segments of said continued file transfer and thus blocking the downlink direction.

However, according to an embodiment of the present invention, the monitoring instance 107 senses the increased amount of uplink traffic represented by said MMS message on the TCP layer level, and generates an adjustment signal in order to inform the resource allocation instance 207 in the bearer layer 20 to increase the capacity of the uplink bearer transmission link 60a. Said resource allocation instance 207 now initiates a change in the current maximum number of traffic channels and air interface user rate parameters via a Call Control (CC) User Initiated Service Level (UISL) up-grading. The bearer packets 202 representing transformed TCP segments then do not overflow the bearer packet buffer 203a, but can be transmitted speedily via the increased-capacity bearer transmission link 60a.

After the transfer of the MMS message, the monitoring instance may sense the reduction of the uplink transfer and trigger the resource allocation instance 207 to reduce the maximum number of traffic channels via a further UISL downgrading, so that transmission capacity is not blocked.

If said system represents a General Packet Radio Service (GPRS) system, sensing the increased amount of uplink data by said monitoring device 107 at the TCP layer level and signaling increased uplink transmission capacity requirements to the resource allocation instance 207 of the bearer layer 20 allows an increase in the uplink transmission capacity before actual TCP segments have been transformed into bearer packets and wait in the bearer packet buffer 203a for transmission. Application of the GPRS protocol stack for transmission capacity from the network takes time, so that reducing the time between noticing that transmission capacity is required and the actual application for capacity, as performed by the monitoring device 107 of the present invention, significantly contributes to increase system throughput and helps to reduce spurious TCP segment retransmissions. The monitoring instance 107 according to an embodiment of the present invention thus allows for an improved adaptation of the bearer to the TCP, resulting in an overall improved use of transmission capacity, less spurious TCP segment re-transmissions and increased end user satisfaction. The integration of a monitoring instance 107 may advantageously be accomplished in software, without requiring hardware modifications in mobile terminals or the core network, thus rendering the present invention cost-effective and easy to realize.

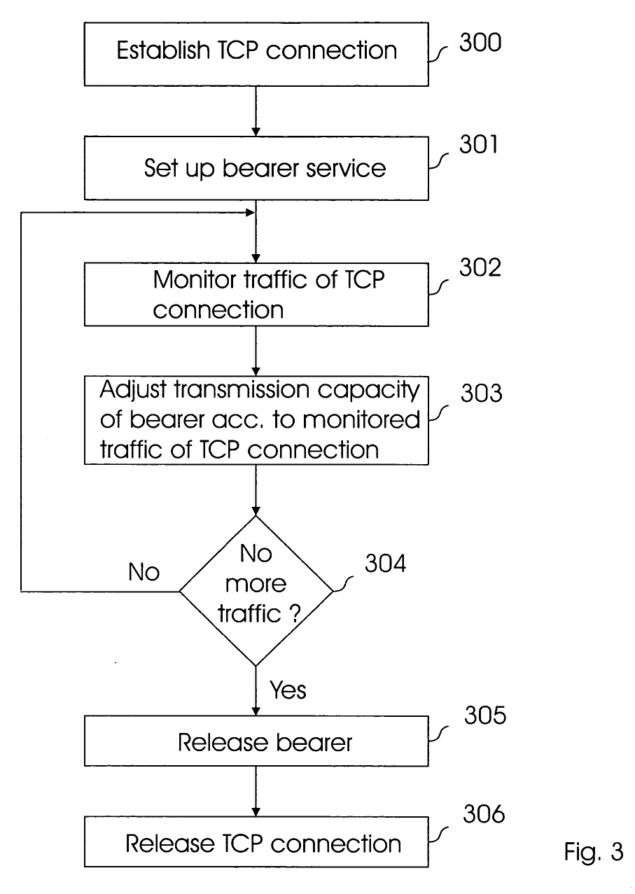

FIG. 3 depicts a flow chart of the method according to an embodiment of the present invention. In a first step 300, a TCP connection is established between peer TCP instances in a transport layer. In a second step 301, a bearer service is set up. For instance, in case of a HSCSD bearer, the maximum number of traffic channels may be fixed. When data traffic on the TCP connection starts, said data traffic of the TCP connection is monitored within the transport layer (step 302), and the transmission capacity of the bearer is adjusted according to the monitored traffic of said TCP connection (step 303). This process is periodically repeated until no more data traffic takes place on the TCP connection, as is tested in step 304. In that case, the bearer is released (step 305), and also the TCP connection is released (step 306).

The invention has been described above by means of a preferred embodiment. It should be noted that there are alternative ways and variations which are obvious to a skilled person in the art and can be implemented without deviating from the scope and spirit of the appended claims, e.g. the schematic representation of the protocol stack of the communication system in FIGS. 1 and 2 may substantially differ from an actual implementation of the TCP and bearer layers. The buffers and transformation instances are to be understood in an illustrative way of describing how TCP segments and bearer packets are processed and stored. Both TCP and bearer layer may be capable of controlling more that one uplink and downlink TCP connection. There may be further relay stations between the mobile terminal and the core network, for instance a Base Station Sub-System (BSS) and a Serving GPRS Support Node between a GPRS station and a Gateway GPRS Support Node (GGSN). Furthermore, data traffic monitoring in a TCP layer is not restricted to wireless bearers only, and the principles of the present invention may equally well be applied to transport layer protocols in general, for instance to mobile terminals that do not use a TCP, but have integrated Media Modules that generate data that is to be transmitted over a bearer service and which can be monitored as well. An example for such a Media Module is the data interface Infra-red Data Association (IrDA) of a mobile terminal.

1. A method for improving transmission performance of a Transport Layer Protocol (TLP) connection that uses a data transmission service of a bearer, comprising:
monitoring data traffic of said TLP connection, and
dynamically adjusting a transmission capacity of said bearer according to said monitored data traffic of said TLP connection.

2. The method according to claim 1, wherein said TLP is a Transport Control Protocol (TCP) or a User Datagram Protocol (UDP).

3. The method according to claim 1, wherein transmission capacity adjustment information is signaled from at least one TLP instance to at least one bearer instance.

4. The method according to claim 1,
wherein said bearer provides uplink and downlink transmission capacity,
wherein said data traffic of said TLP connection comprises uplink and downlink data traffic that is separately monitored, and
wherein said uplink and downlink transmission capacity is at least partially separately adjusted according to said monitored respective uplink and downlink data traffic.

5. The method according to claim 4, wherein said uplink and downlink data traffic is at least partially asymmetric.

6. The method according to claim 1, wherein said data traffic of said TLP connection is monitored at least partially by monitoring a state of at least one TLP segment buffer.

7. The method according to claim 1, wherein said data traffic of said TLP connection is monitored at least partially by monitoring data input to at least one TLP socket.

8. The method according to claim 1, wherein said bearer is a packet-switched or circuit-switched bearer.

9. The method according to claim 1, wherein said bearer is at least partially based on wireless transmission.

10. The method according to claim 1, wherein said bearer is a High-Speed Circuit Switched Data (HSCSD) bearer of a Global System for Mobile Communication (GSM) or of a derivative thereof.

11. The method according to claim 10, wherein said transmission capacity of said bearer is adjusted according to said monitored data traffic of said TLP connection by changing a maximum number of traffic channels, at least one air interface user rate parameter, or both.

12. The method according to claim 11, wherein said change is performed by using a Call Control (CC) User Initiated Service Level (UISL) up- and downgrading procedure.

13. The method according to claim 1, wherein said bearer is a General Packet Radio Service (GPRS) bearer or an Enhanced GPRS (EGPRS) bearer of a Global System for Mobile Communications (GSM) or of a derivative thereof.

14. The method according to claim 13, wherein said transmission capacity of said bearer is adjusted according to said monitored data traffic of said TLP connection by influencing a Temporary Block Flow (TBF) setup.

15. The method according to claim 1, wherein said bearer is a bearer that uses Code Division Multiple Access (CDMA) as medium access technique, in particular a bearer of an IS-95 system or of a derivative thereof.

16. The method according to claim 1, wherein said bearer is a Universal Mobile Telecommunications System (UMTS) bearer or a bearer of a derivative of said system.

17. A computer program with instructions operable to cause a processor to perform the method steps of claim 1.

18. A computer program product comprising a computer program with instructions operable to cause a processor to perform the method steps of claim 1.

19. A device for improving transmission performance of a Transport Layer Protocol (TLP) connection that uses a data transmission service of a bearer, comprising:
means for monitoring data traffic of said TLP connection, and
means for dynamically adjusting the transmission capacity of said bearer according to said monitored data traffic of said TLP connection.

20. A mobile terminal using a Transport Layer Protocol (TLP) connection that uses a data transmission service of a bearer, comprising:
means for monitoring data traffic of said TLP connection, and
means for dynamically adjusting transmission capacity of said bearer according to said monitored data traffic of said TLP connection.

21. The device according to claim 20, wherein said TLP is a Transport Control Protocol (TCP) or a User Datagram Protocol (UDP).

22. The device according to claim 20, further comprising means for signaling transmission capacity adjustment information from at least one TLP instance to at least one bearer instance.

23. The device according to claim 20,
wherein said bearer provides uplink and downlink transmission capacity,
wherein said data traffic of said TLP connection comprises uplink and downlink data traffic that is separately monitored, and
wherein said uplink and downlink transmission capacity is at least partially separately adjusted according to said monitored respective uplink and downlink data traffic.

24. The device according to claim 23, wherein said uplink and downlink data traffic is at least partially asymmetric.

25. The device according to claim 20, wherein said data traffic of said TLP connection is monitored at least partially by monitoring a state of at least one TLP segment buffer.

26. The device according to claim 20, wherein said data traffic of said TLP connection is monitored at least partially by monitoring data input to at least one TLP socket.

27. The device according to claim 20, wherein said bearer is a packet-switched or circuit-switched bearer.

28. The device according to claim 20, wherein said bearer is at least partially based on wireless transmission.

29. The device according to claim 20, wherein said bearer is a High-Speed Circuit Switched Data (HSCSD) bearer of a Global System for Mobile Communication (GSM) or of a derivative thereof.

30. The device according to claim 20, wherein said bearer is a General Packet Radio Service (GPRS) bearer or an Enhanced GPRS (EGPRS) bearer of a Global System for Mobile Communications (GSM) or of a derivative thereof.

31. The device according to claim 20, wherein said bearer is a bearer that uses Code Division Multiple Access (CDMA) as medium access technique, in particular a bearer of an IS-95 system or of a derivative thereof.

32. The device according to claim 20, wherein said bearer is a Universal Mobile Telecommunications System (UMTS) bearer or a bearer of a derivative of said system.

33. A system, comprising:
at least one terminal, and
at least one network interface,
wherein said at least one terminal and said at least one network interface use a Transport Layer Protocol (TLP) connection that uses a data transmission service of a bearer, wherein data traffic of said TLP connection is monitored and wherein a transmission capacity of said bearer is dynamically adjusted according to said monitored data traffic of said TLP connection.
